(19) United States
(12) Patent Application Publication
(10) Pub. No.: US 2018/0370674 A1
(43) Pub. Date: Dec. 27, 2018

(54) PARTIALLY COLLAPSIBLE FLUID DISPENSING CONTAINER

(71) Applicant: NESTEC S.A., Vevey (CH)

(72) Inventors: Andrea Rigardo, Konolfingen (CH); Arnaud Gerbaulet, Oye et Pallet (FR); Andre Noth, Pully (CH); Fabien Ludovic Agon, Valeyres-Sous-Rances (CH)

(21) Appl. No.: 15/777,261

(22) PCT Filed: Nov. 15, 2016
(86) PCT No.: PCT/EP2016/077775

§ 371 Date: May 18, 2018

(30) Foreign Application Priority Data
Nov. 20, 2015 (EP) 15195547.3

(51) Int. Cl. B65D 1/02; B67D 1/00

(52) U.S. Cl. CPC B65D 1/0292; B67D 1/0001

(57) ABSTRACT

The present invention relates to a partially collapsible dispensing container (100) extending along a longitudinal axis (110) between a first end and second end, the container comprising an opening (20) for dispensing fluid at said second end, wherein the container (100) comprises a collapsible part (102) and a retaining part (101), wherein the collapsible part and the retaining part are arranged successively along the longitudinal axis (110) and the collapsible part (102) is configured to collapse at least partially inside the retaining part (101) by the application of pressure substantially in a direction of the container longitudinal axis (110). The invention further relates to a system comprising a partially collapsible dispensing container and further comprising a mechanical actuation device (10) configured to apply a pressure on the collapsible part (102) of the container (100) substantially parallel to the container longitudinal axis (110) in order to allow dispensing of the fluid inside.

### FIELD OF THE INVENTION

The present invention relates to a partially collapsible fluid dispensing container for dispensing fluid, in particular, viscous fluid. More particularly, the invention relates to aseptically processable containers that are partially collapsible allowing the emptying of their content.

### BACKGROUND OF THE INVENTION

Aseptic packaging is usually used for the packaging of spoilable substances, such as foodstuffs or beverages for example. In aseptic packaging techniques the spoilable substance is sterilised by rapid exposure to heat, rapidly cooled to an ambient temperature and then filled into a sterilised package. The sterilised package is then sealed in a sterile environment. Aseptic packaging techniques retain more nutrients and properties of the spoilable substance and use less energy than retort sterilisation techniques.

Aseptic packaging techniques are often used in applications where the spoilable substance is flowable and in these situations the aseptic packaging techniques utilise squeezable pouches. The squeezable pouches contain the spoilable substance. The squeezable pouches, when squeezed, collapse to allow a content of the squeezable pouches to be readily emptied by the application of pressure. The squeezable pouches are often made up of flexible, multi-layer, multi-materials (e.g. plastics, metals, papers). The flexible, multi-layer, multi-materials (e.g. plastics, metals, papers) are often manufactured to have specific barriers properties to the outside environment.

However, these squeezable pouches can pose some problems, particularly when dealing with viscous fluids, as they do not allow the complete delivery of their content easily or they would require complicated means in order to effect a complete emptying of the content inside them.

WO 2010/080280 A1 describes a partially collapsible bottle where one wall collapses over another by the suction effect created from the emptying of the fluid content, typically a nutritional composition administered to a patient. However, this device will not allow a proper dispensing when a viscous fluid is contained inside of it, neither a complete dispensing of its content simply by the emptying suction effect.

A similar device is shown for example in document US 2007/272705 A1 of the prior art, where the two walls of a container collapse over each other by the content being emptied with no ventilation. The main application of this container is for pressurized infusions. However, it would not allow a proper nor easy delivery of a fluid viscous product comprised inside.

There is a need to provide a container which overcomes the drawbacks in the state of the art and which is therefore able to deliver viscous fluids in an easy and hygienic way, allowing the complete emptying of the product comprised inside.

### OBJECT AND SUMMARY OF THE INVENTION

According to a first aspect, the invention relates to a partially collapsible dispensing container extending along a longitudinal axis between a first end and second end, the container comprising an opening for dispensing fluid at said second end, such that the container comprises a collapsible part and a retaining part, the collapsible part and the retaining part being arranged successively along the longitudinal axis and the collapsible part is configured to collapse at least partially inside the retaining part by the application of pressure substantially in a direction of the container longitudinal axis.

Preferably, the collapsing part of the container is configured to collapse by inverting its shape and conforming to substantially the inner shape of the retaining part in order to allow the dispensing of the fluid inside the container. Also preferably, the collapsible part extends along the longitudinal axis from the first end towards the retaining part and the retaining part extends along the longitudinal axis from the second end towards the collapsible part.

Typically, according to the invention, in non-collapsed state, the retaining part and the collapsible part of the container have substantially complementary shapes. The collapsible part typically forms a wall of lower rigidity than the wall formed by the retaining part.

The thickness of the collapsible part is typically comprised between 20% and 70% of the thickness of the retaining part, being preferably of around 40% of the thickness of the retaining part.

Preferably, the thickness of the collapsible part is of around 250 microns, +/−100 microns, the thickness of the retaining part being of around 600 microns, +/−100 microns.

According to the invention, the partially collapsible dispensing container is typically made of aseptically processable plastics such as one or a combination of: thermoplastic polyolefin(s) taken from the group of linear low-density polyethylene (LLDPE), low-density polyethylene (LDPE), medium-density polyethylene (MDPE), high-density polyethylene (HDPE), polypropylene (PP); and/or polyethylene terephthalate (PET); and/or bio based polymer; and/or polymers making the container substantially compostable such as compostable polyester.

Preferably, the partially collapsible dispensing container of the invention further comprises at least one oxygen barrier layer, such as an ethylene vinyl alcohol (EVOH) layer. More preferably, it further comprises at least a light barrier layer, such as a black layer selected to absorb UV light.

Typically, the partially collapsible dispensing of the invention is configured as a multilayer, with a configuration such as: LDPE/Black Layer/EVOH/LDPE or MDPE/Black Layer/EVOH/MDPE or HDPE/Black Layer/EVOH/HDPE.

According to a possible embodiment, the wall of the collapsible part of the container is made integral to the wall of the retaining part.

The partially collapsible dispensing container of the invention can be made in one single piece wherein the collapsible part and the retaining part are delimited by a transversal joint, defining the deformation limit of the collapsible part inside the retaining part.

Preferably, the partially collapsible dispensing container is configured as a bottle, comprising an opening through which fluid is delivered and a base on the opposite side to the opening.

Typically, the container of the invention has a volume comprised between 5 ml and 250 ml.

Preferably, the first end of the container of the invention comprises at least one centring recess for a mechanical actuation device.

Typically, the container of the invention comprises inside a fluid aseptically processed, which is shelf-stable, and/or a fluid filled under ultra-clean conditions, with an extended shelf-life.

According to a second aspect, the invention refers to a system comprising a partially collapsible dispensing container as the one described, further comprising a mechanical actuation device configured to apply a pressure on the collapsible part of the container substantially parallel to the container longitudinal axis in order to allow dispensing of the fluid inside.

Preferably, in the system of the invention, the mechanical actuation device comprises a piston having a shape substantially the same as the inner shape of the retaining part.

Typically, the mechanical actuation device is configured to be able to dispense the content of containers having different sizes, collapsing the collapsible part over the retaining part.

In the system of the invention, the mechanical actuation device is configured to collapse the collapsible part over the retaining part up to a transversal joint delimiting the collapsible part and the retaining part.

### BRIEF DESCRIPTION OF THE DRAWINGS

Further features, advantages and objects of the present invention will become apparent for a skilled person when reading the following detailed description of embodiments of the present invention, when taken in conjunction with the figures of the enclosed drawings.

FIGS. 1 a-c show schematic views of partially collapsible fluid dispensing container according to the present invention.

FIG. 2 shows a schematic view in section A-A of the partially collapsible fluid dispensing container according to the present invention represented in FIG. 1a.

FIG. 3 shows a schematic view of a partially collapsible fluid dispensing container according to the present invention, configured as a bottle.

FIG. 4 shows a detailed view of the opening in a partially collapsible fluid dispensing container according to the present invention, configured as a bottle, as per detail B in FIG. 2.

FIG. 5 shows a detailed view of the base in a partially collapsible fluid dispensing container according to the present invention, configured as a bottle, as per detail C in FIG. 2.

FIGS. 6a-e show different steps in the collapsing and inversion of a collapsible part into a retaining part in a partially collapsible fluid dispensing container according to the present invention, configured as a bottle.

FIGS. 7a-d show different steps in the collapsing and inversion of a collapsible part into a retaining part in a partially collapsible fluid dispensing container according to the present invention, configured as a bottle, by means of a piston.

FIG. 8 shows two possible execution sizes of a partially collapsible fluid dispensing container according to the present invention, configured as a bottle.

### DETAILED DESCRIPTION OF EXEMPLARY EMBODIMENTS

The present invention relates to a partially collapsible fluid dispensing container 100 for dispensing fluid, in particular, viscous fluid. More particularly, the invention relates to an aseptically processable container 100 that is partially collapsible allowing the emptying of its content, as it will be further explained in detail.

In the present application, the term “fluid” refers to a flowable substance, essentially to liquid or viscous paste or gel, or a mixture of any one of liquid, viscous, paste, gel, with gas inclusion and/or discrete solid pieces, particles, granules, beads, chips and the like. The fluid can be foodstuff such as a dairy or beverage liquid composition or ice cream mix.

The container 100 of the invention can be an aseptic packaging: it is preferably used for containing and dispensing spoilable substances, more preferably foodstuffs or beverages. The container of the invention is preferably intended for products aseptically processed, which are shelf-stable. However, it can also be convenient for products filled under ultra-clean conditions, having an extended shelf-life.

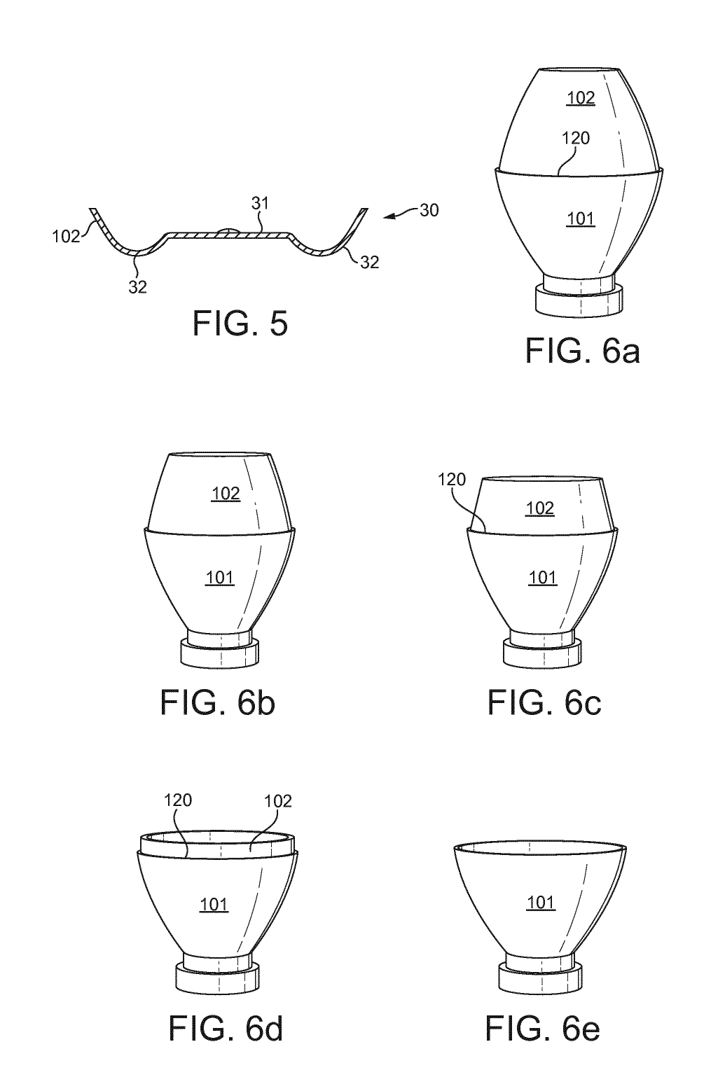

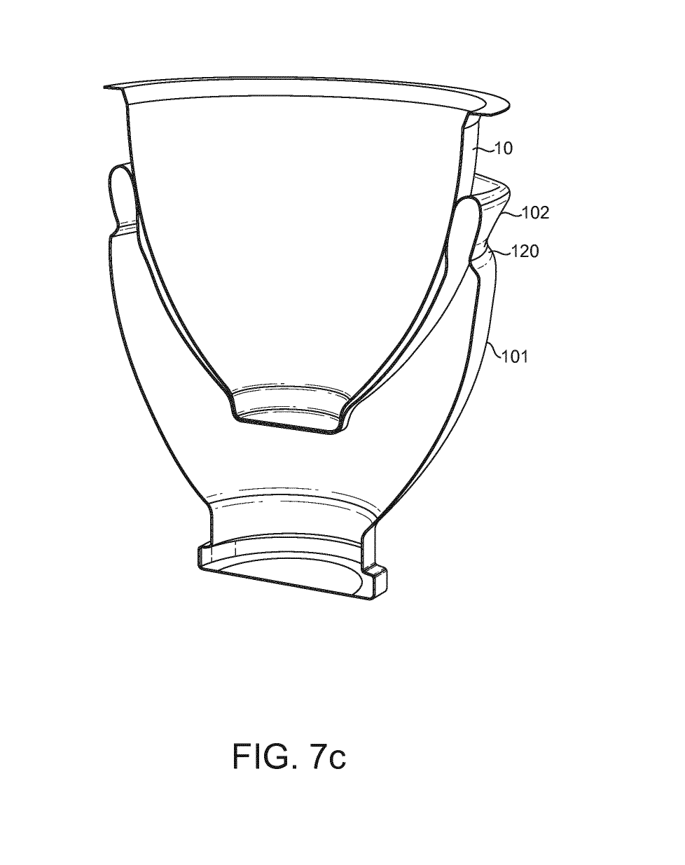

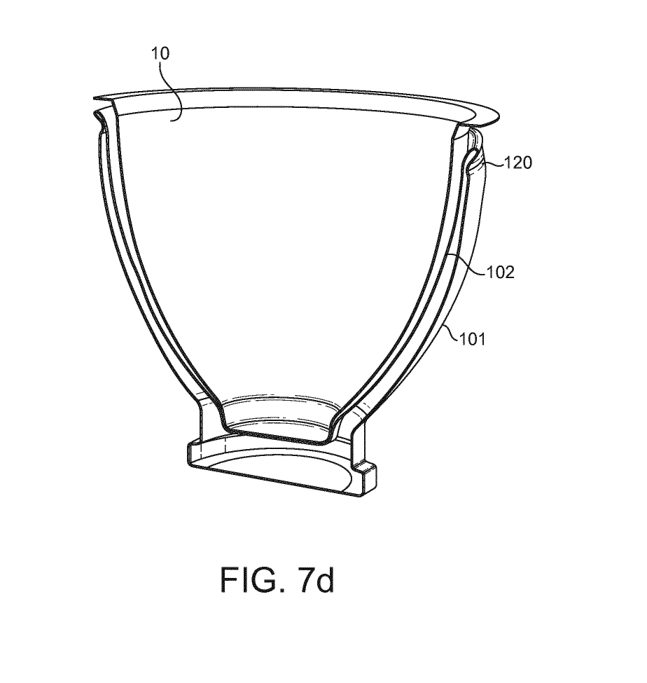

As shown in FIG. 3, the container 100 is preferably configured having the shape of a bottle, though any other shapes are also possible. The container 100 of the invention comprises a retaining part 101 and a collapsible part 102: preferably, the collapsible part 102 is configured to be semi-rigid (it will be named as follows as semi-rigid wall 102) and the retaining part 101 is configured rigid (it will be named as follows as rigid wall 101); in this way, in a collapsed form, the semi-rigid wall 102 conforms to the inner shape of the rigid wall 101. That is to say, the semi-rigid wall 102 is configured to invert its shape when an external force is applied so as to conform to this inner shape of the rigid wall 101. Different steps of this inversion process of the semi-rigid wall 102 over the rigid wall 101 are shown in FIGS. 6a to 6e and FIGS. 7a to 7d attached.

In what follows in the present description, the term “semi-rigid wall” means that the wall is made of a material that is flexible or stretchable and does not resume its original shape or position after pressure has been applied to it. As used in this description, the term “rigid wall” means that the wall is made of a material that is stiff and does resume its original shape, or stays very close to its original shape after pressure has been applied to it.

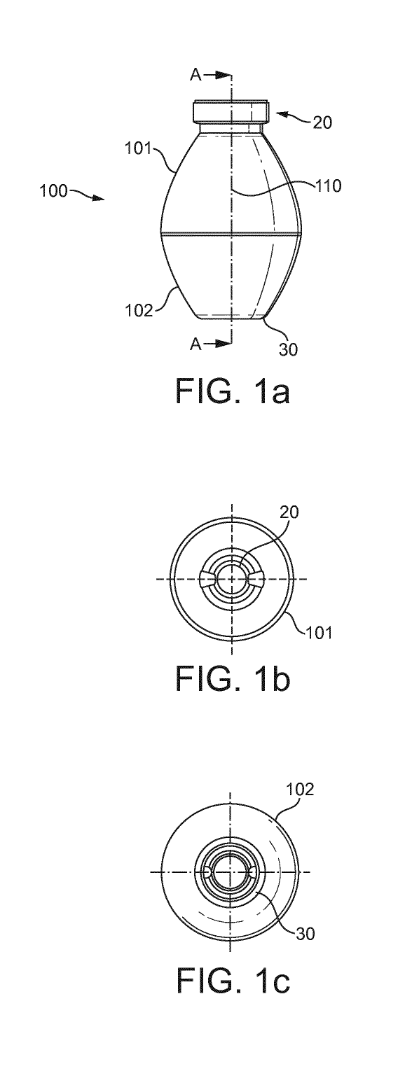

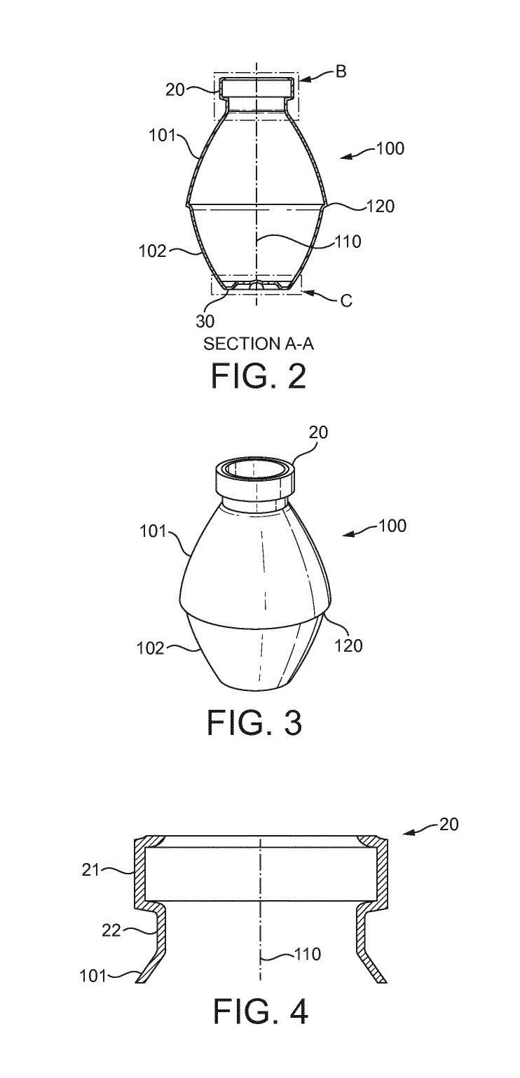

Preferably, the external force applied to the semi-rigid wall 102 in order to collapse it over the inner wall of the rigid wall 101 is exerted by means of a mechanical actuation device 10, preferably a piston, whose external shape conforms to the inner shape of the rigid wall 101, therefore allowing its correct inversion, as shown in FIGS. 7a-d. Such execution allows the complete dispensing of the fluid product inside the container 100 in an easy way and particularly in the case when this product is a viscous fluid. The pressure applied by the piston 10 is exerted substantially in the longitudinal axis 110 of the container 100 or parallel to it. The container 100 comprises, on one of its ends, an opening 20 through which the fluid or product inside can be delivered, this opening 20 being arranged substantially transversely with respect to the longitudinal axis 110 of the container 100 as shown in FIG. 1a or 2, for example. Furthermore, the container 100 also comprises a base 30 arranged substantially transversely with respect to the longitudinal axis 110 of the container, such that the piston 10 exerts an external pressure onto the base 30 directed substantially parallel with respect to the longitudinal axis 110 of the container. Typically, the piston 10 creates a certain positive pressure inside the container for forcing the fluid outside of it through the opening 20 by the application of external compressive forces onto the semi-rigid wall 102 wall of the container.

Therefore, the invention further relates to a system comprising a mechanical actuation device 10 (preferably a piston) dimensioned and shaped as the inner shape of the rigid wall 101 and complementarily to the semi-rigid wall 102 so as to engage it and invert it into the inner shape of the rigid wall 101.

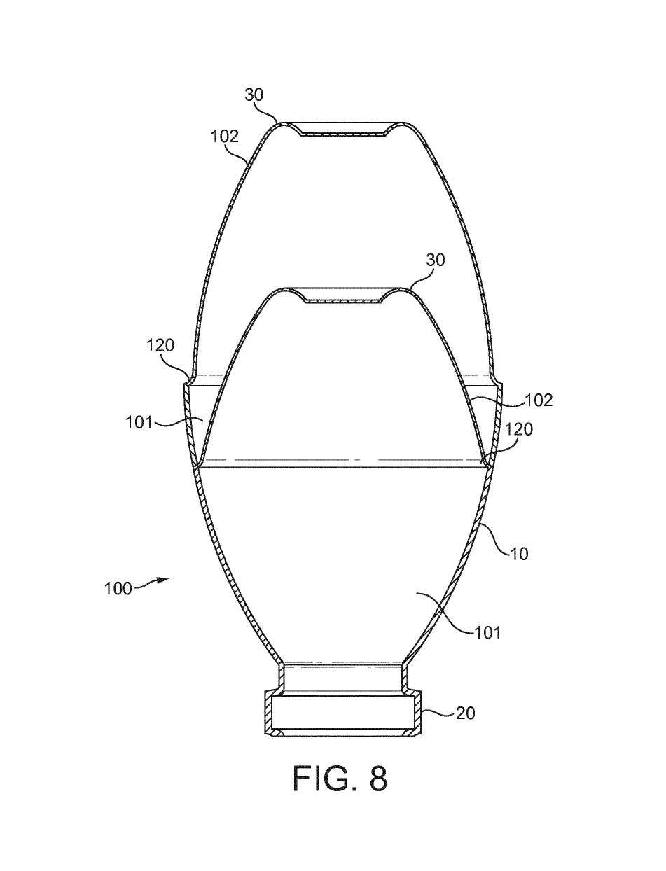

As it is shown in FIG. 8, the same system can be previewed to work with two or more different sizes of the container 100. In the attached FIG. 8, two containers have been represented, a bigger one and a smaller one. Each one of the two containers comprises a collapsible part 102 (or semi-rigid wall 102) and a retaining part 101 (or rigid wall 101): the collapsible part 102 is collapsed and inverts its shape by the force applied by the piston 10. The same piston 10 is able to compress or collapse both sizes of collapsible parts 102, always up to a transversal joint 120 (also called split line) separating both parts, 101 and 102. In both cases, the containers (bigger and smaller) represented in FIG. 8 have the same opening 20 (the same top opening 21 and the same neck portion 22), which is preferable in a system according to the present invention. The piston 10 will be preferably made bigger and according to the inner shape of the retaining part 101 in the bigger size container; therefore, when this same dimensioned piston 10 will be used to compress a smaller sized container, it will stop at the point where the transversal joint 120 is reached. In this way, the same piston 10 (equally dimensioned) will be able to compress both a bigger sized container and a smaller sized container, as schematically shown in FIG. 8 attached. What is important is that the external shape of the piston 10 conforms to the inner shape of the retaining part 101 over which the collapsible part 102 will be compressed in order to allow complete dispensing of the fluid inside.

The container 100, more particularly the opening 20 of the container 100, can be closed by means of a lid or cap (not shown) in the Figures attached), also by means of a technical cap for example: this lid will be removed or opened so as to leave the opening 20 free when the piston 10 applies pressure over the semi-rigid wall 102 of the container, allowing dispensing of the fluid inside. Typically, when the container 100 is filled in aseptic conditions, it is then sealed preferably by a material that is welded to the opening 20. The container 100 can be also sealed by a lid or a screw cap on this opening 20. The container 100 can be sealed by a material that is welded to the opening 20 and a combination of the lid or screw cap to this opening. The sealing of the container 100 is often dependent on the nature of the contents to be filled in the container. It is preferable that the container is sealed with a metal foil such as aluminium.

The container 100 of the invention is preferably made of plastics material and is produced through extrusion blow moulding. The rigid and semi-rigid walls 101 and 102 respectively of the container 100 are created by modulating the flow of plastic and using special pin/bushing configuration. Extrusion blow moulding has the advantage that aseptically processable plastics and the container 100 can be manufactured with a uniform thickness. During extrusion blow moulding pin and bushing tools of the extrusion blow moulding apparatus can be adjusted to adjust the thickness of the container 100. Extrusion blow moulding has the advantage that the container can be manufactured easily into desired shapes; all parts of the container, opening 20, semi-rigid-wall 102, rigid wall 101 and base 30 are singly integrated into the container 100, avoiding the need for separate welding of constituents of the container, which could provide weak points in the container structure. Since the whole container 100 is integrated as a single piece configuring the mentioned container, this can be partially collapsed as explained in order to allow its content be readily and completely emptied. In the Figures attached, a split line or transversal joint 120 has been represented, as joining the two parts, 101 and 102: however, out of the extrusion blow moulding process, no joint 120 can also be obtained, so there will be a continuous transition between the retaining part 101 (rigid wall 101) and the collapsible part 102 (semi-rigid wall 102).

The materials used for the container 100 of the invention are preferably aseptically processable plastics which can be for example, single materials, mixtures of, multilayers of, or combinations thereof, of:
Thermoplastic polyolefin(s), such as linear low-density polyethylene (LLDPE) and/or low-density polyethylene (LDPE) and/or medium-density polyethylene (MDPE) and/or high-density polyethylene (HDPE) and/or polypropylene (PP).
Ethylene vinyl alcohol (EVOH).
Polyethylene terephthalate (PET); and/or bio based polymer; and/or polymers making the container substantially compostable such as compostable polyester.
A thermoplastic polyolefin (selected from of the above) and ethylene vinyl alcohol (EVOH).

The walls of the container 100 comprise at least one oxygen barrier layer (this is typically obtained by the ethylene vinyl alcohol (EVOH) layer) and light barrier layer, such as e.g. a black layer. This black layer is selected to absorb UV light, ensuring that the contents of the container 100 are protected from light, which may degrade the contents of the container. It is preferable that the wall of the container 100 is a multilayer of the aseptically processable plastics and is arranged as any one of the thermoplastic(s) polyolefin as noted above and ethylene vinyl alcohol (EVOH). Most preferably the wall is a multilayer and can have one of the following configurations:
LDPE/Black Layer/EVOH/LDPE or
MDPE/Black Layer/EVOH/MDPE or
HDPE/Black Layer/EVOH/HDPE.

These polyethylenes provide a water/moisture barrier to the container 100 and thus prevent any water/moisture entering or leaving the container. These polyethylenes therefore maintain integrity (e.g. freshness) of the contents of the container and prevent any degradation of the container that could be caused by water/moisture.

Typically, the thickness of the semi-rigid wall 102 is of around 250 microns, +/−100 microns. The thickness of the rigid wall 101 is of around 600 microns, +/−100 microns. The thickness of the semi-rigid wall 102 is preferably comprised between 20% to 70% of the thickness of the rigid wall 101, being more preferably of around 40% of the thickness of the rigid wall 101.

The semi-rigid wall 102 is collapsible upon an applied force ranging from 5 N to 1000 N, preferably from 5 N to 500 N, more preferably from 5 N to 100 N. Several tests have been made and they show that the average force to be applied onto the semi-rigid wall 102 when the container is empty from fluid is of about 45 N. As a reference, these tests have been made with an element in the machine compressing this semi-rigid wall 102, moving at a speed of up to 480 mm/min in a direction parallel to the longitudinal axis 110 of the container, the average time for the full compression and inversion of this wall 102 being of around 9 seconds.

The term “aseptically processable plastics” means at least one plastic that can be processed in aseptic conditions without causing any degradation to the plastic and/or degradation of any properties of the plastic.

By the term “compressed” or “collapsed” used in the present description, it should be understood that the container changes its shape when used and does not recover its shape by itself. The collapsible container 100 of the invention, having preferably a shape similar to a bottle, can be delivered compressed or collapsed when empty (as per FIG. 6e, for example) and can be re-blown before its aseptic filling (so it will recover the shape as in FIG. 6a for example). With this configuration, the container will be compressed or collapsed again when being inserted into a system, when the external force from a piston 10 will invert the semi-rigid wall 102 into the rigid wall 101 so as to deliver the product inside.

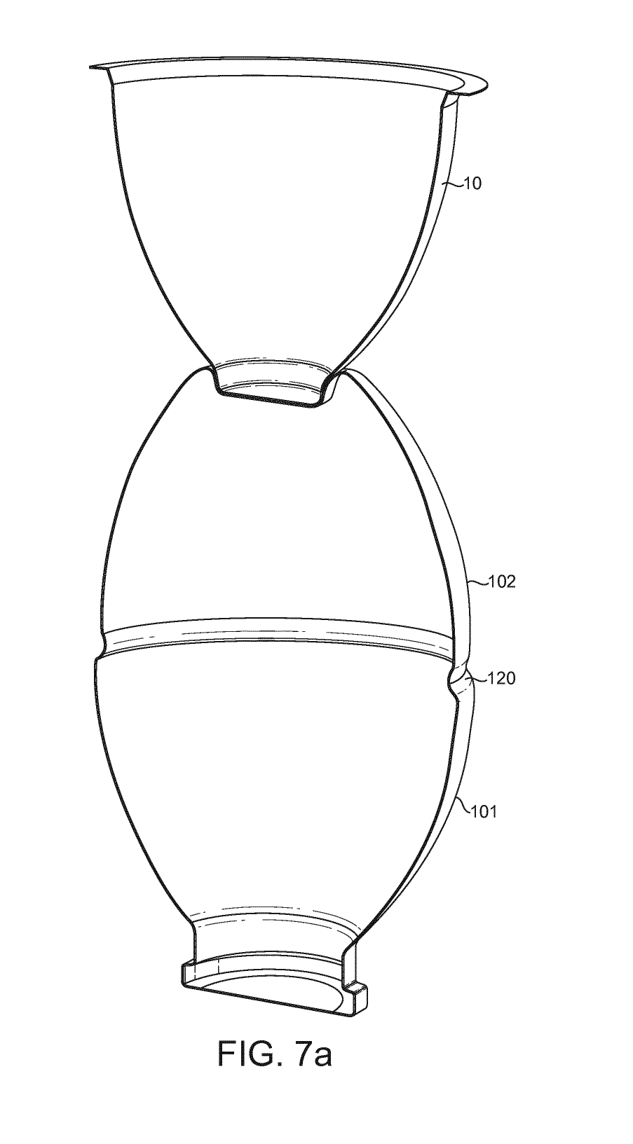

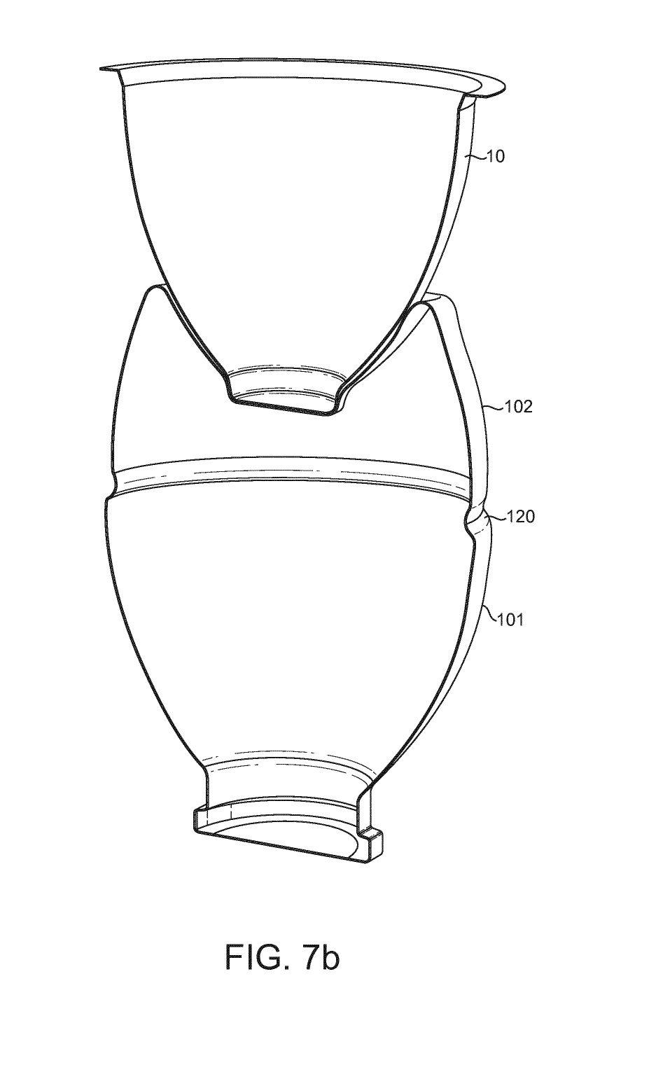

As shown in FIGS. 1b and 4, the opening 20 of the container 100 comprises a neck portion 22 with reduced diameter, opening into a top opening 21 where a lid or cap could be arranged (nor shown). FIGS. 1c and 5 show a detail of the base 30 of the container 100, comprising a standing part 32 preferably annularly shaped, and an inner part of the base 31. FIGS. 2 and 3 also show a transversal joint 120, arranged substantially transversely with respect to the longitudinal axis 110 of the container, and following the shape where the semi-rigid wall 102 and the rigid wall 101 join.

The container 100 has preferably a volume of between 5 ml to 250 ml. The container can have a volume of 10 ml, 25 ml, 50 ml, 75 ml, 100 ml, 125 ml, 150 ml, 175 ml, 200 ml, 225 ml. The dimensions such as radius and height of the body determine the volume of the container 100, these two parameters being modified depending on the intended shape and use of the container.

The aseptically processable plastics of the container 100 according to the present invention ensure that the container can be readily recycled by conventional techniques.

The shape of the container 100 of the present invention is conventional, typically configured as a bottle, easy to hold, fill, package and store and is devoid of any sharp edges as apparent from pouches.

Although the present invention has been described with reference to preferred embodiments thereof, many modifications and alternations may be made by a person having ordinary skill in the art without departing from the scope of this invention which is defined by the appended claims.

1. A partially collapsible dispensing container extending along a longitudinal axis between a first end and second end, the container comprising an opening for dispensing fluid at said second end,
wherein the container comprises a collapsible part and a retaining part,
wherein the collapsible part and the retaining part are arranged successively along the longitudinal axis and the collapsible part is configured to collapse at least partially inside the retaining part by the application of pressure substantially in a direction of the container longitudinal axis.

2. A partially collapsible dispensing container according to claim 1 wherein the collapsing part is configured to collapse by inverting its shape and conforming to substantially the inner shape of the retaining part in order to allow the dispensing of the fluid inside the container.

3. A partially collapsible dispensing container according to claim 1 wherein the collapsible part extends along the longitudinal axis from the first end towards the retaining part and the retaining part extends along the longitudinal axis from the second end towards the collapsible part.

4. A partially collapsible dispensing container according to claim 1 wherein, in non-collapsed state, the retaining part and the collapsible part have substantially complementary shapes.

5. A partially collapsible dispensing container according to claim 1 wherein the collapsible part forms a wall of lower rigidity than the wall formed by the retaining part.

6. A partially collapsible dispensing container according to claim 1, wherein the thickness of the collapsible part is comprised between 20% and 70% of the thickness of the retaining part, being preferably of around 40% of the thickness of the retaining part.

7. A partially collapsible dispensing container according to claim 1 wherein the thickness of the collapsible part is of around 250 microns, +/−100 microns, the thickness of the retaining part being of around 600 microns, +/−100 microns.

8. A partially collapsible dispensing container according to claim 1 made of aseptically processable plastics.

9. A partially collapsible dispensing container according to claim 8 comprising at least one oxygen barrier layer.

10. A partially collapsible dispensing container according to claim 8 further comprising at least a light barrier layer.

11. A partially collapsible dispensing container according to claim 8 configured as a multilayer.

12. A partially collapsible dispensing container according to claim 1, wherein the wall of the collapsible part is made integral to the wall of the retaining part.

13. A partially collapsible dispensing container according to claim 1 being made in one single piece wherein the collapsible part and the retaining part are defined by a transversal joint, defining the deformation limit of the collapsible part inside the retaining part.

14. A partially collapsible dispensing container according to claim 1 configured as a bottle, comprising an opening through which fluid is delivered and a base on the opposite side to the opening.

15. A partially collapsible dispensing container according to claim 1 having a volume comprised between 5 ml and 250 ml.

16. A partially collapsible dispensing container according to claim 1 wherein the first end comprises at least one centering recess for a mechanical actuation device.

17. A partially collapsible dispensing container according to claim 1, comprising inside a fluid aseptically processed, which is shelf-stable, and/or a fluid filled under ultra-clean conditions, with an extended shelf-life.

18. System comprising a partially collapsible dispensing container according to claim 1, further comprising a mechanical actuation device configured to apply a pressure on the collapsible part of the container substantially parallel to the container longitudinal axis in order to allow dispensing of the fluid inside.

19. System according to claim 18 wherein the mechanical actuation device comprises a piston having a shape substantially the same as the inner shape of the retaining part.

20. System according to claim 18 wherein the mechanical actuation device is configured to be able to dispense the content of containers having different sizes, collapsing the collapsible part over the retaining part.

21. System according to claim 20 wherein the mechanical actuation device is configured to collapse the collapsible part over the retaining part up to a transversal joint defining the collapsible part and the retaining part.
